(19) United States
(12) Patent Application Publication
(10) Pub. No.: US 2023/0130835 A1
(43) Pub. Date: Apr. 27, 2023

(54) IMAGE PROCESSING SYSTEM AND RELATED IMAGE PROCESSING METHOD FOR IMAGE ENHANCEMENT BASED ON REGION CONTROL AND TEXTURE SYNTHESIS

(71) Applicant: Realtek Semiconductor Corp., HsinChu (TW)

(72) Inventors: CHON HOU SIO, HsinChu (TW); Chia-Wei Yu, HsinChu (TW)

(73) Assignee: Realtek Semiconductor Corp., HsinChu (TW)

(21) Appl. No.: 17/696,912

(22) Filed: Mar. 17, 2022

(30) Foreign Application Priority Data
Oct. 25, 2021 (TW) 110139490

(51) Int. Cl. G06T 5/50; G06T 11/00; G06T 5/20; G06T 7/11

(52) U.S. Cl. CPC G06T 5/50; G06T 11/001; G06T 5/20; G06T 7/11; G06T 2207/20052; G06T 2207/20084; G06T 2207/20221

(57) ABSTRACT

An image processing system includes: a material image generating circuit, at least one texture generating circuit and an output controller. The material image generating circuit is configured to generate a material image. The at least one texture generating circuit is coupled to the material image generating circuit, and configured to adjust texture characteristics of the material image to generate at least one texture image. The output controller is coupled to the at least one texture generating circuit, and configured to analyze regional characteristics of a source image to generate an analysis result, determine a region weight according to the analysis result, and synthesize the source image with the at least one texture image according to the region weight, thereby to generate an output image.

### BACKGROUND OF THE INVENTION

### 1. Field of the Invention

The present invention relates to image processing, and more particularly to an image processing system and a related image processing method for performing image enhancement based on region control and texture synthesis techniques.

### 2. Description of the Prior Art

Mid-frequency and high-frequency details of compressed videos or streaming videos are often lost due to compression algorithms. Typically, image enhancement can be relied upon to restore certain lost details. Common image enhancement approaches includes sharpening and deep-learning image enhancement. Sharpening generally involves increasing the high-frequency details in image, such as using a high-pass filter to enhance textures and edge areas in the images. However, sharpening cannot restore the textures and edges that have been completely destroyed during compression. On the other hand, deep learning image enhancement trains an image enhancement model by inputting a large number of various images to the model, allow the model to learn relationship between image contents, details and textures. When enhancing compressed images, the trained image enhancement model can guess what kind of details and textures are lost based on the image contents, and accordingly regenerate it. However, the disadvantage of deep learning image enhancement is that the regenerated texture and details are difficult to control, which may lead to unnatural artifacts. Also, deep-learning image enhancement requires higher computing power.

### SUMMARY OF THE INVENTION

In view of this, the present invention provides an image enhancement processing technique based on texture synthesis and region control. The image enhancement processing of the present invention has the ability to generate details, and can provide a decent enhancement effect even when details of source images are completely lost. Since the present invention does not utilize a deep learning network to generate details, the computing power is not critical. In various embodiments of the present invention, a material image generating circuit is utilized to generate material images, and texture characteristics of the material images are adjusted through one or more texture generating circuit, thereby to generate texture images. Textures in the texture images may have specific directionalities and densities. In embodiments of the present invention, multiple texture images are generated by different configurations, thereby improving the adaptability to restoring different types of details in source images. After that, based on the analysis of regional characteristics of the source image (such as frequency, brightness, semantic segmentation or motion of object), synthesis intensities of texture images are regionally controlled to improve adjustability and matching degree between generated textures and lost details of the source images. As such, the image enhancement effects of texture images can be regionally controller, thereby achieving better and more natural results.

According to one embodiment, an image processing system is provided. The image processing system comprises: a material image generating circuit, at least one texture generating circuit and an output controller. The material image generating circuit is configured to generate a material image. The at least one texture generating circuit is coupled to the material image generating circuit, and configured to adjust texture characteristics of the material image to generate at least one texture image. The output controller is coupled to the at least one texture generating circuit, and configured to analyze regional characteristics of a source image to generate an analysis result, determine a region weight according to the analysis result, and synthesize the source image with the at least one texture image according to the region weight, thereby to generate an output image.

According to one embodiment, an image processing method is provided. The image processing method comprises: generating a material image, adjusting texture characteristics of the material image to generate at least one texture image; analyzing regional characteristics of a source image to generate an analysis result; determining a region weight according to the analysis result; and synthesizing the source image with the at least one texture image according to the region weight, thereby to generate an output image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an image processing system according to a first embodiment of the present invention.

FIG. 2 illustrates how region weight is determined according to regional characteristics of a source image.

FIG. 3 illustrates a schematic diagram of an image processing system according to a second embodiment of the present invention.

FIG. 4 illustrates a schematic diagram of an image processing system according to a third embodiment of the present invention.

FIG. 5 illustrates a schematic diagram of an image processing system according to a fourth embodiment of the present invention.

FIG. 6 illustrates a flow chart of an image processing method according one an embodiment of the present invention.

FIG. 7 illustrates how to implement an image processing method using hardware devices according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known structures, materials or steps have not been presented or described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

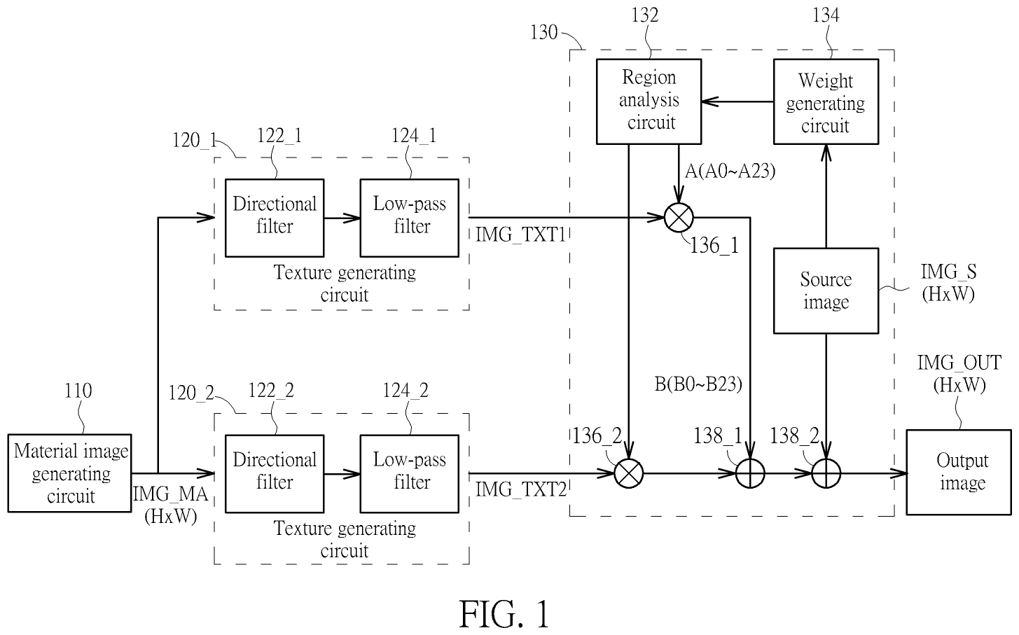

Please refer to FIG. 1, which illustrates a schematic diagram of an image processing system according to one embodiment of the present invention. As shown in the figure, an image processing system 100 is configured to perform image enhancement processing on a source image IMG_S to generate an output image IMG_OUT. The image processing system 100 includes a material image generating circuit 110, texture generating circuits 120_1-120_2, and an output controller 130. Please note that, although there are only two texture generating circuits 120_1-120_2 presented in the drawing, one of ordinary skill in the art should be able to realize an image processing system with more or fewer texture generating circuits after fully understanding the concept of the present invention from the following descriptions. Such modifications should still fall within the scope of the present invention.

The function of the material image generating circuit 110 is to generate a material image IMG_MA (whose image size is H×W, identical to the size of the source image IMG_S). In one embodiment, the material image generating circuit 110 may be a random noise generating circuit, which may generate an image having noise with a random distribution. In some embodiments, the random noise generating circuit can be implemented by a linear feedback shift register (LFSR) or a hardware random number generator (HRNG) using thermal noise. The material image IMG_MA generated by the material image generating circuit 110 will be provided to the texture generating circuits 120_1 and 120_2.

The function of the texture generating circuits 120_1-120_2 is to adjust texture characteristics of the material image IMG_MA, and convert the material image IMG_MA into textures with a specific preference and distribution. In one embodiment, each of the texture generating circuits 120_1-120_2 includes one or more filters, which adjust the directionality and the density of the noise in the material image IMG_MA. In the embodiment shown in FIG. 1, the texture generating circuits 120_1-120_2 comprises directional filters 122_1-122_2 and low-pass filters 124_1-124_2. The direction filters 122_1-122_2 are operable to change the directionality of the noise in the material image IMG_MA, while the low-pass filters 124_1-124_2 are operable to change the density of the noise in the material image IMG_MA. Through such adjustments, the texture generating circuits 120_1-120_2 can generate unique texture images IMG_TXT1 and IMG_TXT2 (whose image size can be identical to that of the source image IMG_S, both are H×W). The texture images IMG_TXT1 and IMG_TXT2 are applicable for enhancing different types of details in the source image IMG_S. Please note that in some embodiments of the present invention, the texture generating circuit 120_1-120_2 may include more or fewer filters or other types of filters, or these filters may be arranged in a different order (such as, the low-pass filter first, and then the directional filter). Based on the above descriptions, those skilled in the art to which the present invention pertains should be able to understand how to change the texture characteristics of the source image IMG_MA through different types or different numbers of filters, thereby to generate a specific texture image. The texture images IMG_TXT1 and IMG_TXT2 generated by the texture generating circuits 120_1-120_2 will be provided to the output controller 130. The output controller 130 will synthesize the source image IMG_S with the texture images IMG_TXT1 and IMG_TXT2.

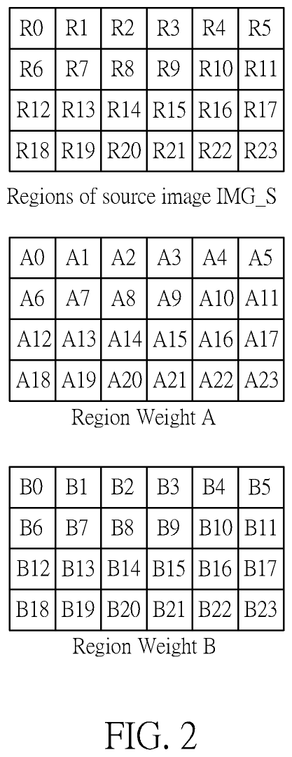

The output controller 130 includes a region analysis circuit 132, a weight generating circuit 134, multiplying units 136_1-136_2, and adding units 138_1-138_2. The function of the output controller 130 is to detect regional characteristics of the source image IMG_S, and perform weight control on texture synthesis accordingly, thereby to achieve a decent image enhancement effect. The region analysis circuit 132 is operable to perform region analysis on the source image IMG_S. As shown in FIG. 2, the region analysis circuit 132 may divide the source image IMG_S into 6×4 regions R0-R23, and analyze the regional characteristic of each region. The regional analysis unit 132 can analyze one or more characteristics (but is not limited to): regional frequency (by converting the source image IMG_S to frequency domain), regional brightness, regional semantics (i.e., type of region, such as grass, water or sand) which can be determined by semantic segmentation, and regional motion (i.e., motion in region). The region analysis circuit 132 quantifies the obtained regional frequency, regional brightness, regional semantics, regional motion and/or other characteristics to generate the analysis result. The analysis result generated by the region analysis circuit 132 will be provided to the weight generating circuit 134.

The weight generating circuit 134 generates a region weight A corresponding to the texture image IMG_TX1 and a region weight B corresponding to the texture image IMG_TX2 according to the analysis result. As shown FIG. 2, the region weights A and B include 6×4 weight coefficients A0-A23 and B0-B23, respectively, indicating synthesis intensities for the texture image IMG_TXT1 and the texture image IMG_TXT2 relative to each region of the source image IMG_S. For example, a weight coefficient A11 of the region weight A indicates a synthesis intensity that should be applied when synthesizing a region R11 of the source image IMG_S with a corresponding region in the texture image IMG_TXT1. A weight coefficient B15 of the region weight B indicates a synthesis intensity that should be applied when synthesizing a region R15 of the source image IMG_S with a corresponding region in the texture image IMG_TXT2. It should be noted that, the number of regions that the source image IMG_S is divided into as well as the number of weight coefficients included in the region weights A and B are not limitations of the present invention. There should be other combinations according to various other embodiments of the present invention.

Furthermore, directionality and density of textures in the texture image IMG_TXT1 and the texture image IMG_TXT2 may lead to their respective suitability for enhancing of different types of image contents and details. For example, the texture image IMG_TXT1 may be relatively suitable for enhancing details in darker regions, while the texture image IMG_TXT2 may be relatively suitable for enhancing details in brighter regions. In one embodiment, the texture image IMG_TXT1 may be relatively suitable for enhancing details of the grass, while the texture image IMG_TXT2 may be relatively suitable for enhancing details of the water surface. In one embodiment, the texture image IMG_TXT1 may be relatively suitable for enhancing details of objects in motion, while the texture image IMG_TXT2 may be relatively suitable for enhancing details of motionless objects. After obtaining the analysis result generated by the region analysis circuit 132 regarding the regional characteristics of the source image IMG_S, the weight generating circuit 134 can determine the region weights A and B according to the texture characteristics of the texture images IMG_TXT1 and IMG_TXT2, thereby accentuating or reducing the influence of texture images IMG_TXT1 and IMG_TXT2 on a specific region of the source image IMG_S. For example, if the texture characteristics of a texture image are suitable for a specific region of the source image, the weight corresponding to the specific region is accentuated (i.e., adaptive detail enhancement). On the other hand, if the texture characteristics of a texture image are not suitable for a specific region of the source image, the weight corresponding to the specific region is reduced (i.e., adaptive detail reduction). It is also available to accentuate the weights of all the texture images with respect to the specific region or reduce the weights of all the texture images with respect to the specific region. Once the weight generating circuit 134 determines the region weights A and B, the multiplying units 136_1-136_2 and the adding units 138_1-138_2 can use the weight coefficients A0-A23 and B0-B23 to synthesize the source image IMG_S with the texture images IMG_TXT1 and IMG_TXT2, thereby to produce the output image IMG_OUT.

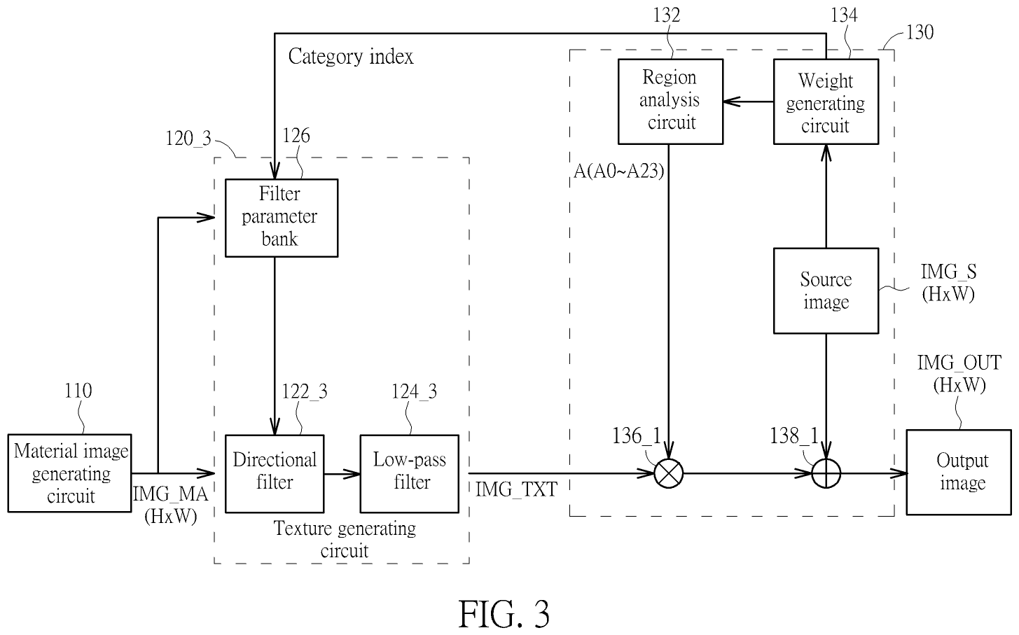

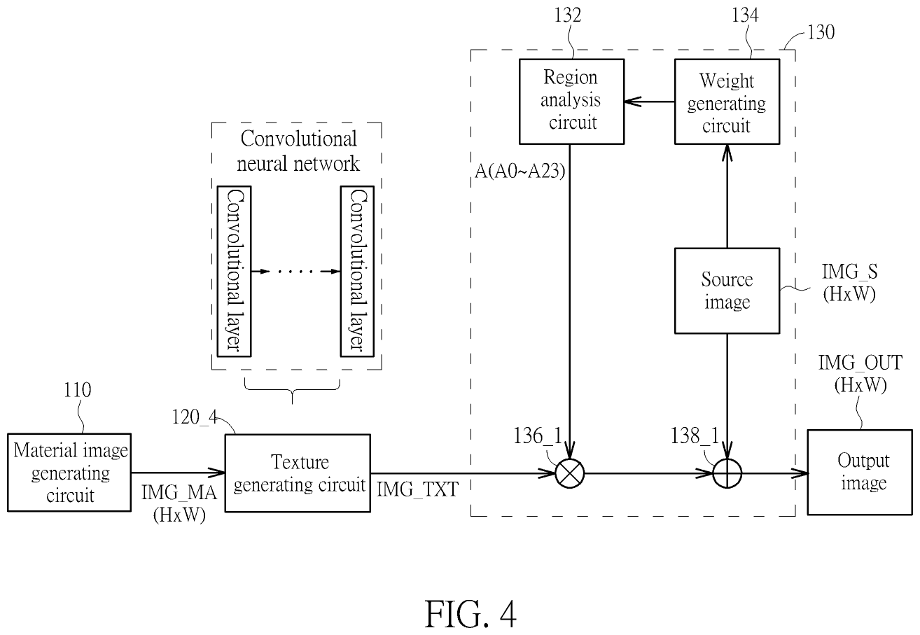

It can be understood from the above descriptions that the texture image IMG_TXT1 and the texture image IMG_TXT2 will affect the adaptability of the image processing system 100 to processing source images with different contents. Therefore, in other embodiments of the present invention, the image processing system 100 may have more texture generating circuits to generate more texture images having different directionalities and different densities in texture distribution, so as to restore details for images with various details better. In addition, in embodiments shown in FIG. 3 and FIG. 4, texture generating circuits with different architectures are provided. In an embodiment shown in FIG. 3, filter parameters of the directional filter 122_3 and/or the low-pass directional filter 124_3 in the texture generator 120_3 are determined according to the analysis result of the region analysis circuit 132. For example, after the region analysis circuit 132 analyzes the semantics of a specific region in the source image IMG_S, a filter parameter bank 126 outputs corresponding filter parameters for the directional filter 122_3 and/or the low-pass filter 124_3 according to a category index directed to the analyzed semantics of the specific region, thereby to generate the texture image IMG_TXT. In such embodiment, since the texture image IMG_TXT generated by the texture generating circuit 120_3 has direct adaptability to the source image IMG_S, more texture generating circuits are not needed. With single texture generating circuit, it is still possible to achieve restoration of different types of lost details. In an embodiment shown in FIG. 4, the texture generating circuit 120_4 can even be implemented by a convolutional neural network. Similarly, the texture image IMG_TXT generated by the texture generating circuit 120_4 is directly adaptable to the source image IMG_S, so other texture generating circuits can be omitted.

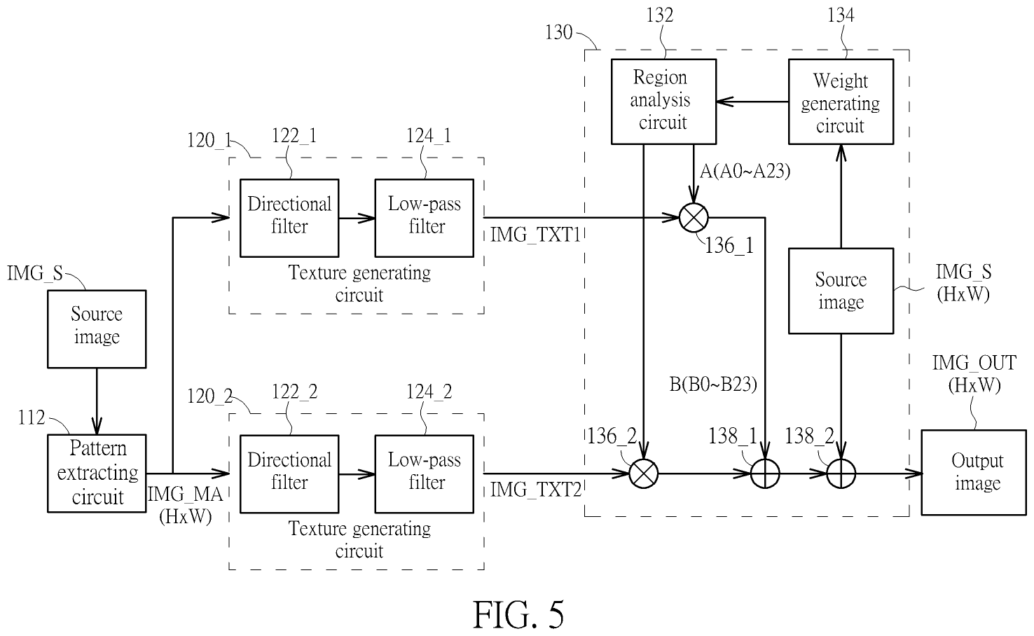

In other embodiments of the present invention, the material image generating circuit can be implemented by a pattern extracting circuit. As shown in an embodiment of FIG. 5, a pattern extracting circuit 112 is configured to retrieve a pattern with a specific frequency from the source image IMG_S, thereby to generate the material image IMG_MA. According to the material image IMG_MA, texture images are generated by the following texture generating circuits 120_1-120_2. Then, the source image IMG_S are synthesized with the texture images. The pattern extracting circuit 112 may include a Sobel Filter or a discrete cosine transform unit, so as to extract image regions with specific frequencies from the source image IMG_S to be the material image IMG_MA.

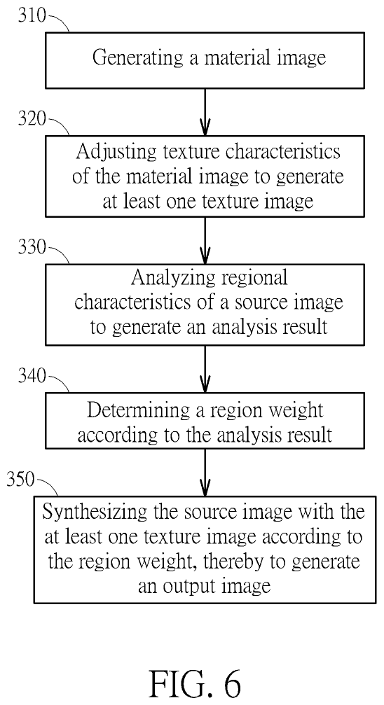

FIG. 6 illustrates a flow chart of an image processing method according to one embodiment of the present invention. As shown in the figure, the image processing method of the present invention includes the following steps:

S310: generating a material image;

S320: adjusting texture characteristics of the material image to generate at least one texture image;

S330: analyzing regional characteristics of a source image to generate an analysis result;

S340: determining a region weight according to the analysis result; and

S350: synthesizing the source image with the at least one texture image according to the region weight, thereby to generate an output image.

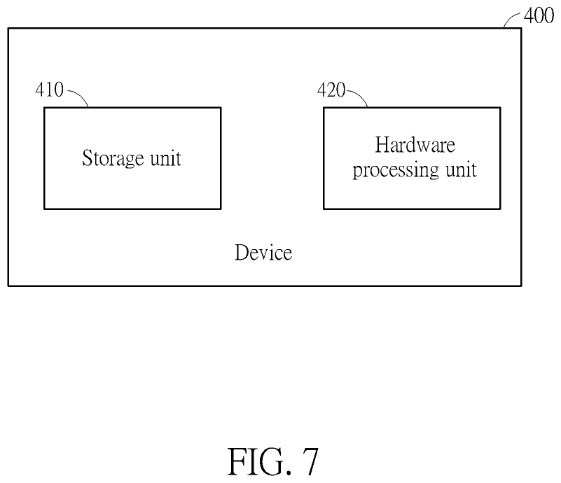

Since the principle and specific details of the foregoing steps have been described expressly in the above embodiments, further description will not be repeated here. It should be noted, that the above flow may be able to achieve better enhancement processing and further improve enhancement effect by adding other extra steps or making appropriate modifications and adjustments. Furthermore, all the operations in the above embodiments of the present invention can be implemented by a device 400 shown in FIG. 7. Specifically, a storage unit 410 (e.g., non-volatile memory or volatile memory) in the device 400 can be used to store program codes, commands, variables, or data. A hardware processing unit 420 (e.g., a general-purpose processor) in the device 400 can execute the program codes and instructions stored in the storage unit 410, and refer to the variables or data therein to perform all the operations in the above embodiments.

In summary, the image enhancement processing of the present invention has the ability to produce details, so it can still exert a certain enhancement effect even when details of the source image are completely lost. As the deep learning network is not utilized to generate details in the present invention, the requirements on computing resources are relatively low. In embodiments of the present invention, the material image generating circuit or the pattern extracting circuit is utilized to generate the material image, and one or more texture generating circuits are utilized to adjust the texture characteristics of the material image to generate texture images. In the embodiments of the present invention, multiple texture images are generated by different settings, thereby improving the adaptability to restoring different types of lost details in the source image. After that, the regional characteristics of the source image (such as, frequency, brightness, semantic segmentation or object motion) are analyzed. When the source image are synthesized with the texture images, the intensity of the enhancement effect is able to be controlled by regions, thereby improving adjustability, and also improving the matching degree of generated texture and lost details in the source image, achieving better and more natural image enhancement effects.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing system, comprising:
a material image generating circuit, configured to generate a material image,
at least one texture generating circuit, coupled to the material image generating circuit, configured to adjust texture characteristics of the material image to generate at least one texture image; and
an output controller, coupled to the at least one texture generating circuit, configured to analyze regional characteristics of a source image to generate an analysis result, determine a region weight according to the analysis result, and synthesize the source image with the at least one texture image according to the region weight, thereby to generate an output image.

2. The image processing system of claim 1, wherein the material image generating circuit comprises:
a random noise generating circuit, configured to generate the material image having random noise, wherein the random noise generating circuit includes a linear feedback shift register (LFSR), or a hardware random number generating circuit (HRNG) based on thermal noise.

3. The image processing system of claim 1, wherein the material image generating circuit comprises:
a pattern extracting circuit, configured to extract a pattern with a specific frequency from the source image to generate the material image, wherein the pattern extracting circuit includes a Sobel filter or a discrete cosine transform unit.

4. The image processing system of claim 1, wherein the at least one texture generating circuit comprises:
a directional filter, configured to perform directional filtering on the material image to generate a directional-filtered image; and
a low-pass filter, coupled to the directional filter, configured to perform low-pass filtering on the directional-filtered image to generate the at least one texture image.

5. The image processing system of claim 4, wherein the at least one texture generating circuit further comprises:
a filter parameter bank, configured to provide one or more sets of specific filter parameters for at least one of the directional filter and the low-pass filter for performing filtering based on the analysis result.

6. The image processing system of claim 1, wherein the at least one texture generating circuit comprises:
a convolutional neural network is configured to process the material image to generate the at least one texture image.

7. The image processing system of claim 1, wherein the output controller comprises:
a region analysis circuit, configured to divide the source image into N×M regions, and respectively determine a plurality of regional characteristics of the N×M region, thereby to obtain the analysis result; and
a weight generating circuit, coupled to the region analysis circuit, configured to determine a plurality of weight coefficients respectively corresponding to the N×M regions according to the analysis result, wherein the region weight is composed of the plurality of weight coefficients;
wherein the regional characteristics include one or more characteristics of: regional frequency, regional brightness, regional semantic, and regional motion.

8. An image processing method, comprising:
generating a material image,
adjusting texture characteristics of the material image to generate at least one texture image;
analyzing regional characteristics of a source image to generate an analysis result;
determining a region weight according to the analysis result; and
synthesizing the source image with the at least one texture image according to the region weight, thereby to generate an output image.

9. The image processing method of claim 8, wherein the step of generating the material image comprises:
utilizing a random noise generating circuit to generate the material image having random noise, wherein the random noise generating circuit includes a linear feedback shift register (LFSR), or a hardware random number generating circuit (HRNG) based on thermal noise.

10. The image processing method of claim 8, wherein the step of generating the material image comprises:
utilizing a Sobel filter or a discrete cosine transform unit to extract a pattern with a specific frequency from the source image to generate the material image.

11. The image processing method of claim 8, wherein the step of generating the at least one texture image comprises:
performing directional filtering on the material image to generate a directional-filtered image; and
performing low-pass filtering on the directional-filtered image to generate the at least one texture image.

12. The image processing method of claim 11, wherein the step of generating the at least one texture image comprises:
determining one or more sets of specific filter parameters according to the analysis result; and
performing directional filtering or low-pass filtering according to the one or more sets of specific filter parameters.

13. The image processing method of claim 8, wherein the step of generating the at least one texture image comprises:
utilizing a convolutional neural network to process the material image to generate the at least one texture image.

14. The image processing method of claim 8, wherein the step of generating the analysis result:
dividing the source image into N×M regions, and respectively determining a plurality of regional characteristics of the N×M region, thereby to obtain the analysis result, wherein the regional characteristics include one or more characteristics of: regional frequency, regional brightness, regional semantic, and regional motion; and
the step of determining the region weight comprises:
determining a plurality of weight coefficients respectively corresponding to the N×M regions according to the analysis result, wherein the region weight is composed of the plurality of weight coefficients.
